(19) United States
(12) Patent Application Publication
(10) Pub. No.: US 2010/0101063 A1
(43) Pub. Date: Apr. 29, 2010

(54) COMBINATION STRUCTURE OF AN URN FOR PETS' CREMATE REMAINS

(76) Inventors: Shen Chin Chen, Douliou (TW); Jin Huei Chan, Douliou (TW); Chin Lung Lee, Douliou (TW)

Correspondence Address: SINORICA, LLC, 2275 Research Blvd., Suite 500, ROCKVILLE, MD, 20850, US

(21) Appl. No.: 12/565,289

(22) Filed: Sep. 23, 2009

(30) Foreign Application Priority Data
Oct. 24, 2008 (TW) 097218990

(51) Int. Cl. A61G 17/08

(52) U.S. Cl. 27/1

(57) ABSTRACT

A combination structure of an urn for pets' cremate remains comprises an inner jug, an outer jug and locking keys. The outer jug can be separated. The inner jug can be put into the separated outer jug and the separated outer jug can be closed by means of several locking keys so as to achieve the object of easily getting access to and encapsulating the bone ash.

### BACKGROUND OF THE INVENTION

1. Technical Field

A combination structure of an urn for pets' cremate remains comprises an inner jug, an outer jug and locking keys. The outer jug can be separated. The inner jug can be put into the separated outer jug and the separated outer jug can be closed by means of several locking keys so as to achieve the object of easily getting access to and encapsulating the bone ash.

2. Description of the Related Art

Cinerary/bone ash urns are well-known in prior art, and typically have a lid, a jug body and an inner jug. The main purposes of the structure of the known urn for cremate remains are to keep the urn for cremate remains from being humidified, fire, separating, falling on the ground due to accidents such as earthquake.

For example, Taiwan utility model patent No. 304331, entitled “improved structure of urn for cremate remains,” discloses an urn for cremate remains having an inner jug and an outer jug made of glass fiber material so as to prevent the jug body from breaking. However, there is not any effort to keep the bone ash from being humidified or to easily get access to the bone ash.

Further, Taiwan utility model patent No. 284370, entitled “combination structure of urn for cremate remains,” discloses an urn for cremate remains having an inner jug. A flange on a lid of the inner jug is used to be snapped with protrusions and snapping supporters on the inner wall of the inner jug so as to seal the inner jug and to prevent the inner jug from being separated. However, it is laborious to close or open the inner jug, and it is not easy to get access to the bone ash.

Still further, Taiwan utility model patent No. 279335, entitled “improved structure of urn for cremate remains,” discloses an urn for cremate remains having an outer jug, an outer lid, an inner jug and an inner lid. The inner lid has a plurality of uneven bend flanges to serve as shock absorbers. The inner lip is laterally rotated to be firmly attached to the inner jug by mean of slope so as to seal the inner jug and to prevent the inner jug from being separated. However, it is laborious to close or open the inner jug, and it is not easy to get access to the bone ash.

Still further, Taiwan utility model patent No. 274092, entitled “protector for urn for cremate remains,” discloses an urn for cremate remains having a spring for upward pushing an upper lid. The upper lid and the jug body can be snapped by means of the uneven peripheries of the lip and the jug upper portion. A spring plate or a spring is used to hold or support the inner jug so as to prevent the bone ash in the inner jug from damage while the urn for cremate remains is moved or falls. However, there is still a drawback of hard getting access to the bone ash.

### SUMMARY OF THE INVENTION

With the trend of few-children and aged society, more and more people treat pets as one member of their family members. The raisers of those pets have a deep relationship with their pets. Particularly, a lot of people have pets, but the lifetime of the pets is most likely shorter than that of their raisers. The situation of the aged population structure is getting severe more and more. For sustainable development of the earth for the future of our progeny, the existing requirement of the environment protection is getting severe more and more. Therefore, cremation is the first consideration for the dead body of humans or pets.

Founding on piety and love, people usually keep the bone ash of the forerunners or the pets, and elaborate on completely protecting and preserving the bone ash of the forerunners and the pets. In order to keep the treasured affect and relationship between the pets and the raisers in the long term, there is a present need to provide a device for safely and closely keeping the bone ash which is meaningful to those raisers and those progeny.

The first object of the present invention is to provide an urn for cremate remains comprising a bone ash outer jug and a bone ash inner jug. The bone ash outer jug comprises a bone ash inner jug container. The bone ash inner jug is molded out of a mixture of calcium silicate and bone ash. The bone ash inner jug is horizontally located in the bone ash inner jug container or the bone ash inner jug is vertically located in the bone ash inner jug container.

The second object of the present invention is to provide an urn for cremate remains comprising a bone ash outer jug and a bone ash inner jug. The bone ash outer jug comprises a bone ash inner jug container and a protrusion. The bone ash inner jug is molded out of a mixture of calcium silicate and bone ash. The bone ash inner jug is horizontally located in the bone ash inner jug container and is supported by the protrusion.

The third object of the present invention is to provide an urn for cremate remains comprising a bone ash outer jug and a bone ash inner jug. The bone ash outer jug comprises a bone ash inner jug container and elastic blocks. The bone ash inner jug is molded out of a mixture of calcium silicate and bone ash. The bone ash inner jug is horizontally located in the bone ash inner jug container and is softly supported by the elastic blocks.

The fourth object of the present invention is to provide an urn for cremate remains comprising a bone ash outer jug and a bone ash inner jug. The bone ash outer jug comprises a bone ash inner jug container and a magnetic painted section. The bone ash inner jug is molded out of a mixture of calcium silicate and bone ash and comprises a magnetic painted section. The bone ash inner jug is horizontally located in the bone ash inner jug container and is supported without contact.

The fifth object of the present invention is to provide an urn for cremate remains in which the magnetic painted section of the bone ash outer jug is made of ferromagnetic metal materials.

Due to the drawbacks in prior art and the need in the modern society, the present invention provides an urn for cremate remains for sealing the bone ash as well as for easily getting access to the bone ash. The invention may best be understood by reference to the following description of the presently preferred embodiments together with the accompanying drawings.

### BRIEF DESCRIPTION OF THE DRAWINGS

FIG. 1 is a schematic partially-sectioned exploded perspective view showing an urn for cremate remains according to an embodiment of the present invention.

FIG. 1-1 is a schematic partially-sectioned exploded perspective view showing an urn for cremate remains according to another embodiment of the present invention.

FIG. 1-2 is a schematic partially-sectioned exploded perspective view showing an urn for cremate remains according to still another embodiment of the present invention.

FIG. 2 is a schematic perspective view showing an element of an urn for cremate remains according to an embodiment of the present invention.

### DETAILED DESCRIPTION OF THE INVENTION

### Embodiment 1

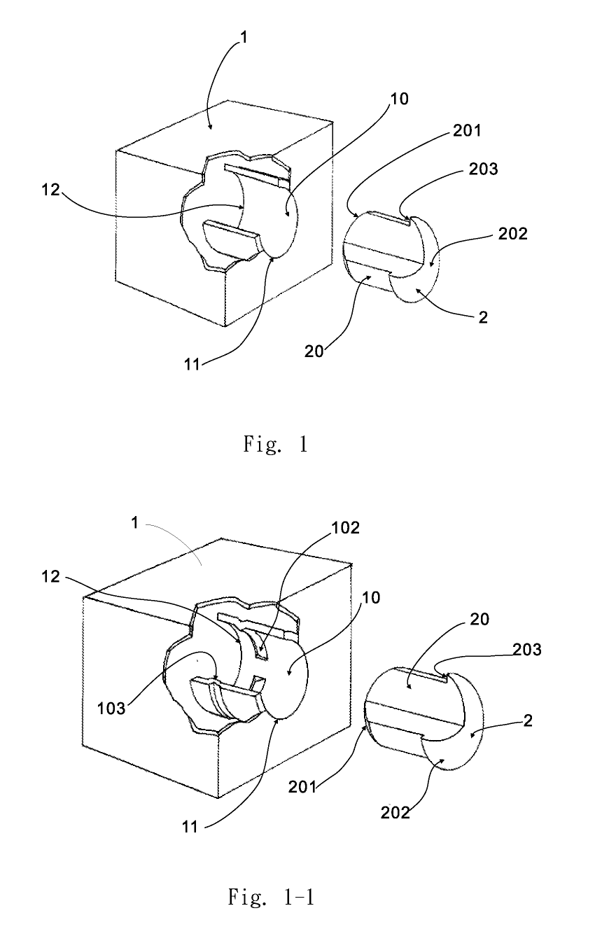

Referring to FIG. 1, the urn for cremate remains according to a first embodiment of the present invention comprises a bone ash outer jug body 1 and a bone ash inner jug 2. The bone ash outer jug body 1 has a bone ash inner jug container 10. One end of the bone ash inner jug container 10 is connected to an outer edge 11 of the bone ash outer jug body 1, and a rear end 12 is open in shape. Further, the bone ash inner jug 2 according to the first embodiment is sintered of a mixture of calcium silicate and bone ash, and has a bone ash inner jug body 20 and a bone ash inner jug head 202. The bone ash inner jug head 202 has a flange 203.

When the bone ash inner jug 2 needs to be engaged with the bone ash outer jug body 1, the bone ash inner jug head 202 of the bone ash inner jug 2 can be held in one's hand, and the bone ash inner jug 2 is moved horizontally to put a front end 201 of the bone ash inner jug body 20 into the outer edge 11 of the bone ash outer jug body 1 so as to lead and insert the bone ash inner jug body 20 into the bone ash inner jug container 10 until the movement of the bone ash inner jug 2 is blocked by the flange 203.

When the bone ash inner jug 2 needs to be taken out from the bone ash outer jug body 1, the flange 203 of the bone ash inner jug head 202 can be held and the bone ash inner jug 2 can be pulled out horizontally.

The processes for engaging the bone ash inner jug 2 with the bone ash outer jug body 1 which is described hereinbefore can also be performed in the vertical direction.

### Embodiment 2

Referring to FIG. 1-1, an urn for cremate remains according to a second embodiment of the present invention is shown, and is structurally similar to the first embodiment. The only difference is that the bone ash inner jug container 10 has a partial protrusion 102 near the rear end 12 of the bone ash inner jug container 10.

When the bone ash inner jug 2 needs to be engaged with the bone ash outer jug body 1, the bone ash inner jug head 202 of the bone ash inner jug 2 can be held in one's hand, and the bone ash inner jug 2 is moved horizontally to put a front end 201 of the bone ash inner jug body 20 into the outer edge 11 of the bone ash outer jug body 1 so as to lead and insert the bone ash inner jug body 20 into the bone ash inner jug container 10 until the bone ash inner jug body 20 is firmly attached to partial protrusion 102 and the movement of the bone ash inner jug 2 is blocked by the flange 203.

The processes for taking out the bone ash outer jug body 1 are similar to the processes described in relation to the first embodiment.

### Embodiment 3

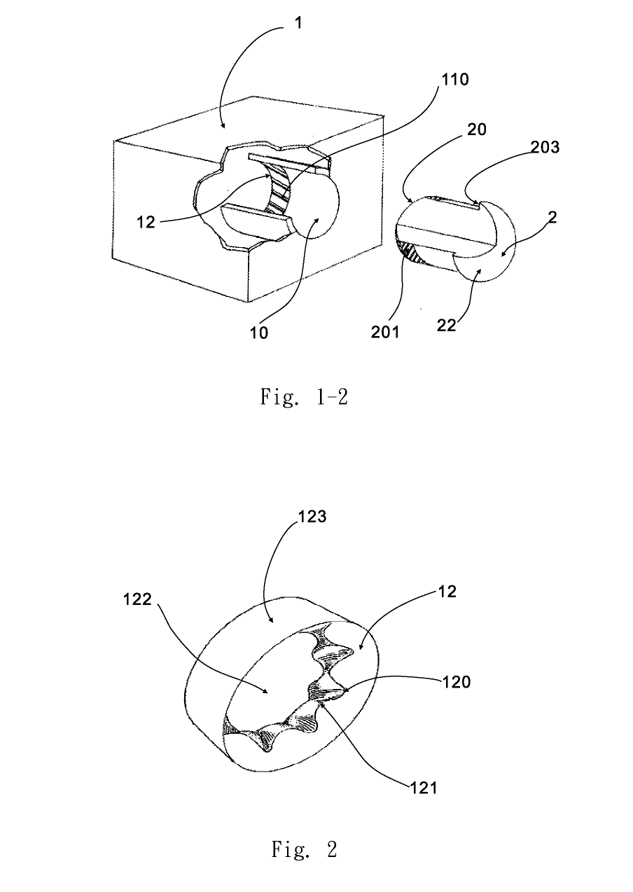

Referring to FIG. 1-1 and FIG. 2, an urn for cremate remains according to a third embodiment of the present invention is shown, and is also structurally similar to the second embodiment. The only difference is that a waved fastening ring 123 is used in place of the partial protrusion 102 near the rear end 12 of the bone ash inner jug container 10. The waved fastening ring 123 is made of an elastic material, such as PVA foam or semi-foam elastic material.

When the bone ash inner jug 2 needs to be engaged with the bone ash outer jug body 1, the flange 203 of the bone ash inner jug head 202 of the bone ash inner jug 2 can be held in one's fingers, and the bone ash inner jug 2 is moved horizontally to put a front end 201 of the bone ash inner jug body 20 into the outer edge 11 of the bone ash outer jug body 1 so as to lead and insert the bone ash inner jug body 20 into the bone ash inner jug container 10 until the bone ash inner jug body 20 pushes peaks 121 of the waved fastening ring 123 to bottoms 120 of the waved fastening ring 123 for softly grasping the bone ash inner jug body 20 and further firmly supporting the bone ash inner jug body 20 and the movement of the bone ash inner jug 2 is blocked by the flange 203.

The processes for taking out the bone ash outer jug body 1 are similar to the processes described in relation to the first embodiment.

### Embodiment 4

Referring to FIG. 1-2, an urn for cremate remains according to a fourth embodiment of the present invention is shown, and is also structurally similar to the first embodiment. The only difference is that the rear end 12 of the bone ash inner jug container 10 has an anode magnetic painted section 110, the bone ash inner jug 2 comprises a bone ash inner jug body 20 and a bone ash inner jug head 202, and an annular cathode magnetic painted section 21 is painted on a front end 201 of the bone ash inner jug body 20.

When the bone ash inner jug 2 needs to be engaged with the bone ash outer jug body 1, the flange 203 of the bone ash inner jug head 202 of the bone ash inner jug 2 can be held in one's fingers, and the bone ash inner jug 2 is moved horizontally to put a front end 201 of the bone ash inner jug body 20 into the outer edge 11 of the bone ash outer jug body 1 so as to lead and insert the bone ash inner jug body 20 into the bone ash inner jug container 10 until the partial protrusion 102 supports the bone ash inner jug body 20 in space due to the attractive force of the different polarities between the anode magnetic painted section 110 of the rear end 12 of the bone ash inner jug container 10 and the annular cathode magnetic painted section 21 of the front end 201 of bone ash inner jug body 20 and the movement of the bone ash inner jug 2 is blocked by the flange 203.

In the above mentioned structure of the fourth embodiment, the anode magnetic painted section 110 annularly located on the rear end 12 bone ash inner jug container 10 can be replaced with ferromagnetic materials, such as iron materials or steel materials.

What is claimed is:

1. An urn for cremate remains, comprising:
A bone ash outer jug comprising a bone ash inner jug container; and
A bone ash inner jug molded out of a mixture of calcium silicate and bone ash, wherein the bone ash inner jug is horizontally located in the bone ash inner jug container.

2. The urn for cremate remains as claimed in claim 1, wherein the bone ash inner jug is vertically located in the bone ash inner jug container.

3. An urn for cremate remains, comprising:
A bone ash outer jug comprising a bone ash inner jug container and a protrusion; and
A bone ash inner jug molded out of a mixture of calcium silicate and bone ash, wherein the bone ash inner jug is horizontally located in the bone ash inner jug container and is supported by the protrusion.

4. An urn for cremate remains, comprising:
A bone ash outer jug comprising a bone ash inner jug container and elastic blocks; and
A bone ash inner jug molded out of a mixture of calcium silicate and bone ash, wherein the bone ash inner jug is horizontally located in the bone ash inner jug container and is softly supported by the elastic blocks.

5. An urn for cremate remains, comprising:
A bone ash outer jug comprising a bone ash inner jug container and a magnetic painted section; and
A bone ash inner jug molded out of a mixture of calcium silicate and bone ash and comprising a magnetic painted section, wherein the bone ash inner jug is horizontally located in the bone ash inner jug container and is supported without contact.

6. The urn for cremate remains as claimed in claim 5, wherein the magnetic painted section of the bone ash outer jug is made of ferromagnetic metal materials.
